(19) United States
(12) Patent Application Publication
(10) Pub. No.: US 2007/0201490 A1
(43) Pub. Date: Aug. 30, 2007

(54) System and method for implementing ethernet MAC address translation

(76) Inventor: Atul B. Mahamuni, San Jose, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/512,804

(22) Filed: Aug. 29, 2006

Related U.S. Application Data
(63) Continuation-in-part of application No. 11/486,479, filed on Jul. 13, 2006.
(60) Provisional application No. 60/699,066, filed on Jul. 13, 2005.

(51) Int. Cl. H04L 12/56

(52) U.S. Cl. 370/395.54

(57) ABSTRACT

A method of using Ethernet MAC addresses translation scheme and encoding extra information is described herein. According to one embodiment, a process includes, maintaining a MAC (media access control) translation table (MAT) within a network element, the MAT table mapping a physical MAC address with a virtual MAC address for each of a plurality of clients of a local network, and performing layer-2 routing on network traffic with respect to each of the clients based on information stored within the MAT. Other methods and apparatuses are also described.

### RELATED APPLICATIONS

This application is a continuation-in-part (CIP) of co-pending U.S. patent application Ser. No. 11/486,479, entitled “System and Method of Routing Ethernet MAC frames using Layer-2 MAC Addresses”, filed Jul. 13, 2006, which claims the benefit of U.S. Provisional Patent Application No. 60/699,066, filed Jul. 13, 2005. The disclosure of the above-identified applications is incorporated by reference herein in its entirety.

### FIELD OF THE INVENTION

The present invention relates generally to the field of network communications. More particularly, this invention relates to address mapping in layer-2 routing.

### BACKGROUND

Ethernet devices are identified using Ethernet MAC address. Ethernet unicast packets carry Globally Unique Ethernet Addresses of source and destination Ethernet devices. These addresses are allocated by IEEE in blocks of 16,777,216 addresses each to Ethernet vendors. In each unicast MAC address, first 3 octets represent an Organizationally Unique Identifier (OUI), and the vendor assigns a unique number for the rest 3 octets.

Traditionally, Routing is performed at Layer-3 (e.g. IP layer), and switching or forwarding is performed at Layer-2. Active paths in Layer-2 networks are traditionally managed using Spanning Tree Protocol.

Address Resolution Protocol is defined in IETF RFC-826. It is used to translate the Protocol Address, such as IP address, to hardware interface address, such as MAC address. When a source needs to find out the hardware address for a given destination protocol address, it broadcasts an ARP Request packet. The destination responds with it's own MAC address using an ARP Reply packet.

U.S. Pat. No. 5,757,924 teaches translation of Ethernet MAC address at a network security device for the purpose of enabling the security device to lock itself to the IP address of it's client, and for ensuring that the client can not emulate the IP address of another client.

EP Patent No. EP1492268A1 teaches translation of Ethernet MAC address at network access node, where addresses include subscriber line identification. This reference is related to an Ethernet based access network, wherein residential subscribers are coupled via an optional remote unit and an aggregation node and via Ethernet switches to an edge node. This reference teaches to encode user device identification, subscriber line identification, remote unit identification, and metro edge identification in the MAC address. From these encodings, the Network Access Provider (NAP) can derive which subscriber line the packets belong to.

### SUMMARY OF THE DESCRIPTION

A method of using Ethernet MAC addresses translation scheme and encoding extra information is described herein. According to one embodiment, a process includes, maintaining a MAC (media access control) translation table (MAT) within a network element, the MAT table mapping a physical MAC address with a virtual MAC address for each of a plurality of clients of a local network, and performing layer-2 routing on network traffic with respect to each of the clients based on information stored within the MAT.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows an exemplary network, and provides an operation flow diagram illustrating the process of MAC Address Translation according to one embodiment.

FIG. 2 is an operation flow diagram that explains handling of ARP packets according to one embodiment.

FIG. 3 is an operational flow diagram that illustrates handling of Layer-2 MAC frames according to one embodiment.

FIG. 4 is an operational flow diagram illustrating a process of handling Layer-2 MAC packets according to one embodiment.

FIG. 5 shows an exemplary encoding Class of Service information in Virtual MAC address according to one embodiment.

### DETAILED DESCRIPTION

A method of using Ethernet MAC addresses translation scheme and encoding extra information such as Class of Service in the virtual MAC addresses is described herein. Further, these virtual MAC addresses can be aggregated and used for Layer-2 routing. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

In one embodiment, a generic method is provided for using Ethernet MAC addresses translation scheme for various purposes such as Layer-2 MAC routing, and controlling the layer-2 switch binding for a given destination MAC address, and using the Class of Service encodings in the virtual MAC addresses for traffic engineering purposes.

Certain advantages of implementing routing at Layer-2 include, but are not limited to:

Higher throughput, as multiple parallel paths are simultaneously used

Fast failover—When one of the active parallel path fails, the other paths still continue to carry data traffic.

Hot-spot reduction—Avoids the situation where a single bridge elected as a root bridge becomes a hot-spot in the network since all traffic needs to traverse through the root bridge

Switches implementing this technology are referred to as Ethernet Frame Routing (EFR) switches. These EFR switches build Layer-2 routing tables in which the key for lookup is a destination MAC address. In order to reduce the number of destination MAC addresses in a layer-2 routing table, it is highly desirable to use a range of MAC addresses that is capable of being aggregated similar to the IP subnets. Since the globally unique MAC addresses assigned to Ethernet devices in a typical Layer-2 network are random and unrelated to each other, a translation mechanism is proposed herein.

This ability to translate MAC addresses provides further advantages. Since virtual MAC addresses are used in a local area network, they do not have to be globally unique as the real MAC addresses have to be. This fact lends itself to allow creation of additional encodings in the virtual MAC addresses. For instance, desired Layer-2 Class of Service (CoS) can be indicated in a few bits in the virtual MAC address; and intermediate Ethernet Frame Routing (EFR) switches can use this information to provide appropriate differentiated handling for the packet streams.

According to certain embodiments, the advantages of MAC address aggregation include, but are not limited to:

Provides a mechanism to use aggregatable MAC addresses, instead of randomly allocated real MAC addresses. This aggregation further enables optimization of the forwarding tables since multiple MAC addresses can be aggregated into a single forwarding entry using the techniques similar to those used for optimizing Layer-3 routing tables such as route prefix summarization.

These virtual MAC addresses enable additional encoding of information such as Layer-2 Class of Service (CoS) in the virtual MAC addresses.

According to certain embodiments, the Layer-2 switch/router is configured to perform the following actions:

1. Classifying traffic received from directly attached end-stations and from rest of the Layer-2 network.

2. Maintaining a MAC-address translation table consisting of Physical or Real MAC addresses and virtual MAC addresses.

3. Intercepting ARP packets and replacing MAC address entries in the ARP packets.

4. Intercepting other Layer-2 packets traveling in local-to-remote network direction, and translating the source MAC address to a Virtual MAC address.

5. Intercepting other Layer-2 packets traveling in remote-to-local network direction, and translating the destination MAC address to a real physical MAC address.

6. Encoding additional information such as Class of Service in the Virtual MAC address, and using the encoded information to perform traffic management functionalities.

7. Performing normal Layer-2 switching functions, such as learning the MAC addresses, Ethernet frame forwarding, multicast, and broadcast handling.

In one embodiment, a method is provided for classifying the traffic according to the direction in which it is traveling. Directly attached end-stations, such as hosts and servers, are termed as Local Network. Rest of the network, connected through other networking devices such as switches or routers, is termed as Remote Network. In one embodiment, the method classifies the packets traveling in local-to-remote direction, and remote-to-local direction. Other two possible directions (local-to-local and remote-to-remote) are handled normally similar to any regular Ethernet switch.

In another embodiment, a method is provided for creating, updating and maintaining a translation table that is used to translate real MAC addresses to virtual MAC addresses and vice versa. Translation entries in this table are dynamic in nature. The method uses common table maintenance techniques such as aging and refreshing for maintenance of MAC Address Translation table.

In yet another embodiment, a MAT switch intercepts ARP response packets from local network to remote network, and replaces the real-MAC address with the virtual MAC address. It may also provide additional encoded data in the virtual MAC addresses.

In still another embodiment, a method is provided for intercepting Layer-2 packets, performing a lookup in the MAC Address Translation table, replacing MAC addresses in the Ethernet header, extracting any encoded information in the packet, and forwarding the packets.

In another embodiment, a method is provided for encoding additional information such as Layer-2 Class of Service (CoS) in the virtual MAC addresses. This information is used by MAT switches in a way similar to the way in which 802.1p based priority signaling is used in VLANs.

Definitions

The definitions in this section apply to this document, unless the context clearly indicates otherwise. The phrase “this document” means the specification, claims, and abstract of this application.

“Including” and its variants mean including but not limited to. Thus, a list including A is not precluded from including B.

A “Layer-2 network” means a network of Layer-2 devices that interconnects a plurality of computing devices using Layer-2 network elements such as Ethernet bridges or Ethernet switches, and the one that is capable of performing Layer-2 bridging/switching services and MAC-address based forwarding functions.

A “frame” includes to an arbitrary or selectable amount of data that may be represented by a sequence of one or more bits. A frame may correspond to a data unit found in Layer-2 of the Open Systems Interconnect (OSI) model.

The term “Address Resolution Protocol” refers to the Internet Engineering Task Force (IETF) standard protocol for address resolution, originally described in RFC 826 document.

The term “Real MAC Address” refers to the real MAC address assigned to the physical network interface of the Ethernet devices. The term “Physical MAC address” refers to the “Real MAC address”, and these two terms are used interchangeably in this document.

The term “Virtual MAC Address” refers to a newly allocated MAC address that is chosen to stand for or represent the real MAC Address. Virtual MAC addresses are different from Real MAC Addresses, and Virtual MAC addresses are not assigned to the physical network interfaces.

The term “Local Network” refers to a set of directly attached end-stations. This local network comprises of end-stations including but not limited to host computers, handheld terminals, and servers.

The term “Remote Network” refers to a set of network-devices such as Ethernet-switches/routers, and the end-stations that are connected using intermediate network-devices such as Ethernet-switches/routers.

The term “MAC Address Translation Table” refers to a mapping or translation table that is configured such that MAT switch can perform lookups to translate between Real MAC addresses and Virtual MAC addresses. The term MAT Table refers to “MAC Address Translation Table”.

The term “MAC Address Translation” refers to a scheme of implementing address translation function that translates Layer-2 Ethernet-MAC addresses. The term MAT means “MAC Address Translation”. The term “MAT switch” refers to a switch configured to perform “MAC Address Translation”. The MAT switch translates real addresses in the local Network to Virtual MAC addresses in the Remote Network.

The term “Class of Service” refers to a level that represents the class or priority of data traffic generated by various applications. The term CoS refers to “Class of Service”.

The term “aggregatable” means a range of addresses that is capable of being aggregated to a single entry that can represent the entire group or range of addresses.

Referring to the drawings, like numbers indicate like parts throughout the figures and this document.

The meaning of “a,” “an,” and “the” include plural references. The meaning of “in” includes “in” and “on.”

Additionally, a reference to the singular includes a reference to the plural unless otherwise stated or is inconsistent with the disclosure herein.

Definitions of terms are also found throughout this document. These definitions need not be introduced by using “means” or “refers” to language and may be introduced by example and/or function performed. Such definitions will also apply to this document, unless the context clearly indicates otherwise.

Illustrative Embodiments

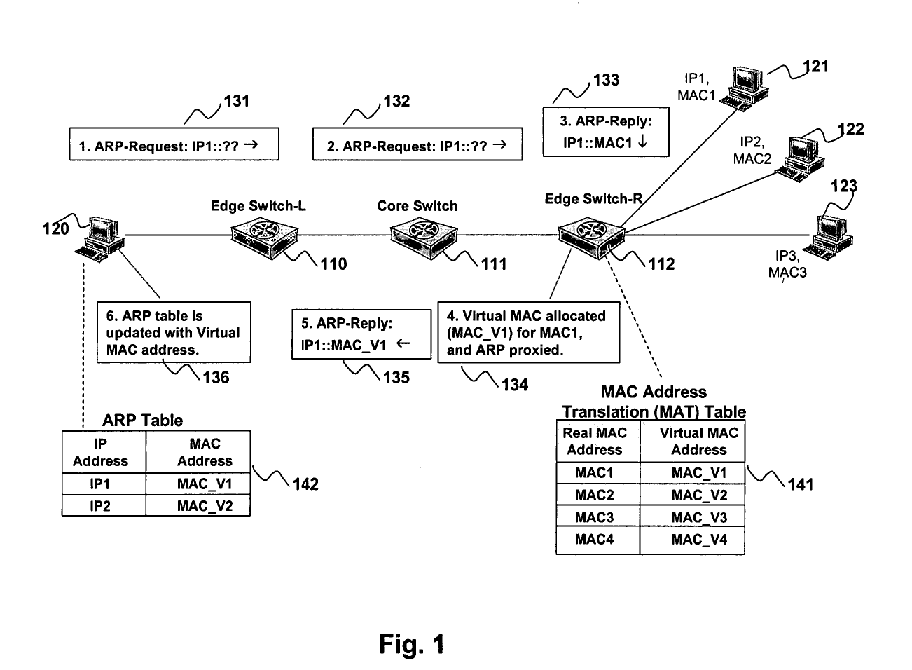

FIG. 1 shows an exemplary Layer-2 network which may be used with one embodiment of the invention. The exemplary network configuration includes Edge switches 110 and 112, a Core switch 111, and end-stations 120, 121, 122, 123. Such a Layer-2 network may contain a plurality of servers, workstations, network appliances, bridges, switches, firewalls, network security devices, routers, gateways, etc. It will be appreciated that the Layer-2 network may include many more components than those shown in FIG. 1. However, the components shown are sufficient to disclose an illustrative environment for practicing the present invention.

Further, FIG. 1 illustrates the basic process of MAC Address Translation according to one embodiment. The process starts at block 131, where an end-station 120 generates and broadcasts an ARP request asking for MAC address of end-station 121. This broadcast is flooded in the Layer-2 network as illustrated by block 132. End-station 121 receives this ARP request and generates an ARP reply 133, with its real MAC address MAC 1. As this ARP reply traverses through the Edge-switch-R 112, the Edge switch 112 intercepts the ARP reply packet, and allocates an entry in the MAT table 141, if one doesn't exist already for translating real MAC address MAC 1 of end-station 121. MAT switch 112 allocates a virtual MAC address (MAC_V1), and populates the entry in the MAT table 141 as shown in block 134. The MAC address is translated from real MAC address MAC1 to virtual MAC address MAC_V1 in the ARP reply packet shown in block 135. This ARP reply 135 reaches the end-station 120, and the end-station updates its local ARP table 142 with the <IP address IP 1 to MAC address MAC_V1>mapping as shown in block 136.

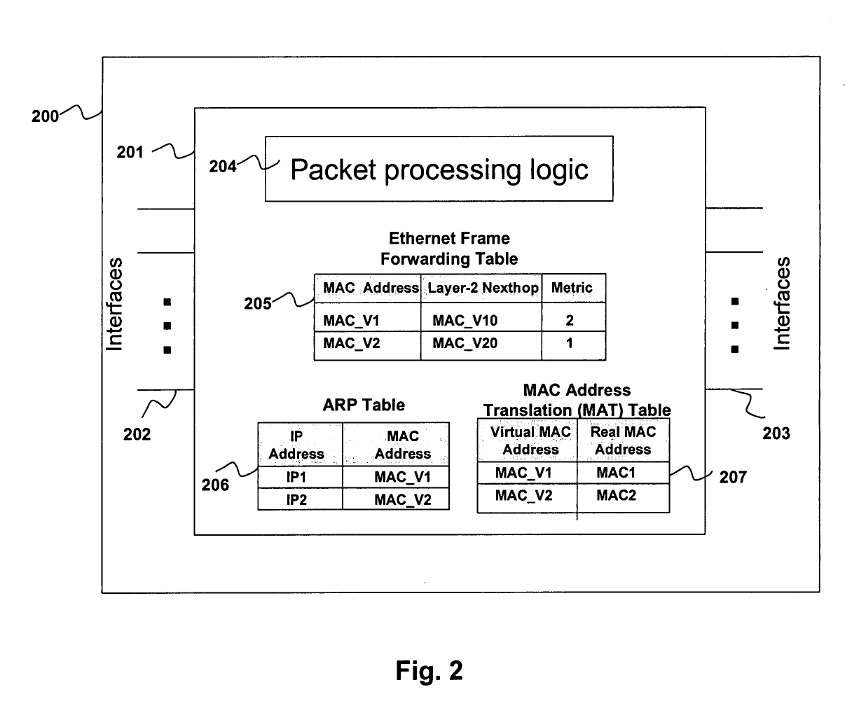

FIG.2 shows an exemplary block diagram 200 of a Ethernet frame forwarding switch 201 with MAT table according to one embodiment. This switch 201 consists of I/O interfaces 202 and 203 that handle transmission and reception of Ethernet frames. Switch 201 also comprises of one or more instances of packet processing logic 204, and an ARP table 206 that translates IP addresses into their corresponding MAC addresses. Switch 201 makes the forwarding decisions based on the Layer-2 forwarding database 205. This forwarding table 205 determines the Layer-2 next hop for a given MAC address. Switch 201 further comprises of MAC Address Translation table 207 that is used for translating the real MAC addresses into aggregatable virtual MAC addresses.

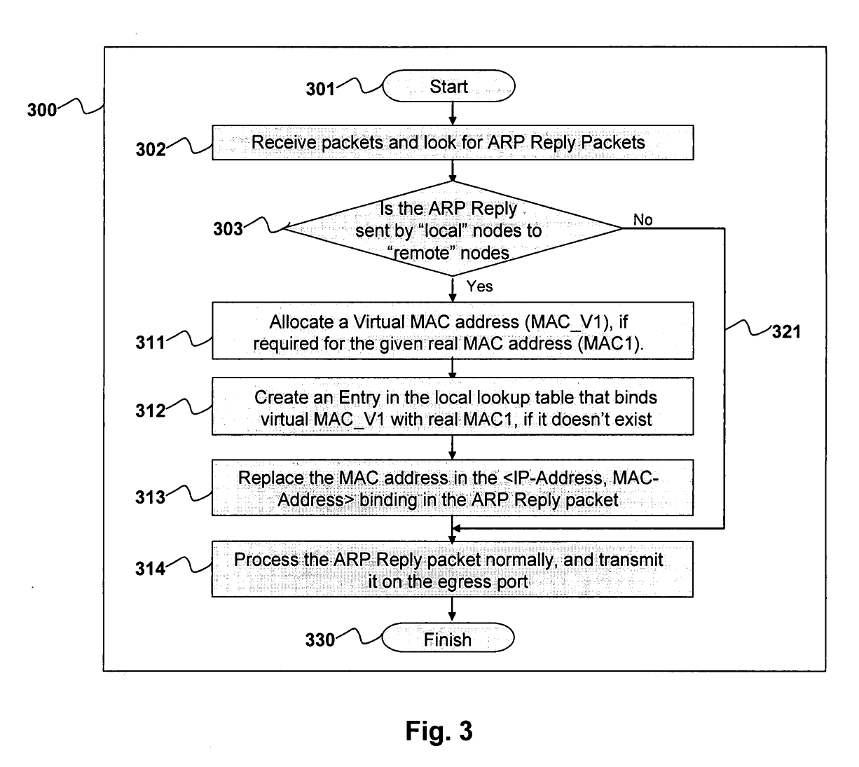

FIG. 3 is an operational flow diagram 300 illustrating a process of handling ARP packets in a MAT switch. The MAT switch is configured to perform a translation service between real MAC addresses and Virtual MAC addresses. Process 300 may be implemented in a system with different components than those contained in Layer-2 network illustrated in FIG. 1.

Moving from a start block 301, the process goes to block 302 where the MAT switch receives packets and looks for ARP Reply packets, including gratuitous ARP Reply packets. Process 300 continues at block 303 where the MAT switch evaluates whether the ARP Reply is sent by nodes in local network to those in remote network. If this condition is true, the process moves to block 311 where the MAT switch performs a lookup to see if a translation entry exists in the MAT table for the real MAC address contained in the ARP Reply packet. If such an entry does not exist, the MAT switch allocates a virtual MAC address, and creates the said entry as shown in block 312. Process 300 goes to block 313 where the MAT switch replaces the real MAC Address in the ARP Reply packet with the virtual MAC address. Moving to block 314, the MAT switch processes the ARP packet normally and transmits it on the egress port. Then process 300 ends at block 330. If the condition in block 303 evaluates to false, the process follows path 321, moves to block 314 and continues as stated above.

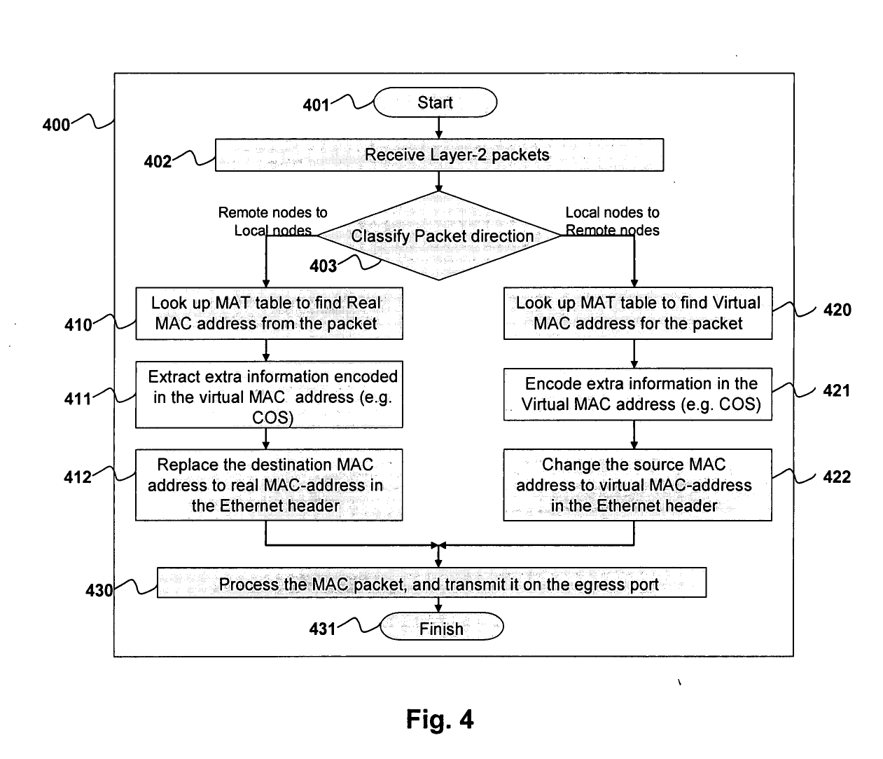

FIG. 4 is an operational flow diagram illustrating a process of handling Layer-2 MAC packets according to one embodiment. Process 400 may be implemented in a system with different components than those contained in Layer-2 network illustrated in FIG. 1.

Starting from block 401, the process goes to block 402 where a MAT switch receives a Layer-2 packet. It then moves to block 403 to classify the packet direction. The MAT switch is interested in looking for local-to-remote network and remote-to-local network directions. If the MAT switch finds that the packet is traveling in remote-to-local network direction, the process moves to block 410 where the MAT switch performs a lookup operation in the MAT table to find if the destination virtual address maps to a real address in the local network. Extra information such as Class of Service can also be extracted from the virtual MAC address as shown in block 411. This Class of Service information is used by the MAT switch to determine relative priority of this packet while storing the packet in its internal queues, as well as for scheduling the packets for transmission. The MAT switch uses this Class of Service information in a way similar to 802.1p priority signaling in VLANs. The process then moves to block 412, and the MAT switch replaces the destination MAC address to the real MAC address. The switch then processes the Layer-2 packet normally and transmits it on the egress port as shown in block 430. The process then terminates at block 431.

If, at block 403, the MAT switch finds the packet direction to be from local-to-remote network, it performs a lookup operation in the MAT table to find if the source real MAC address maps to a virtual address, as shown in block 420. The process then moves to block 421, where the MAT switch encodes extra information, such as Class of Service, in the virtual MAC address. As the packet traverses the network, other switches in the network can use this information about Class of Service for determining relative priority of this traffic. The MAT switches use this Class of Service information in a way similar to 802.1p priority signaling in VLANs. As the process moves to block 422, the MAT switch changes the source MAC address to the Virtual MAC address. The switch then processes the Layer-2 packet normally and transmits it on the egress port as shown in block 430. The process then terminates at block 431.

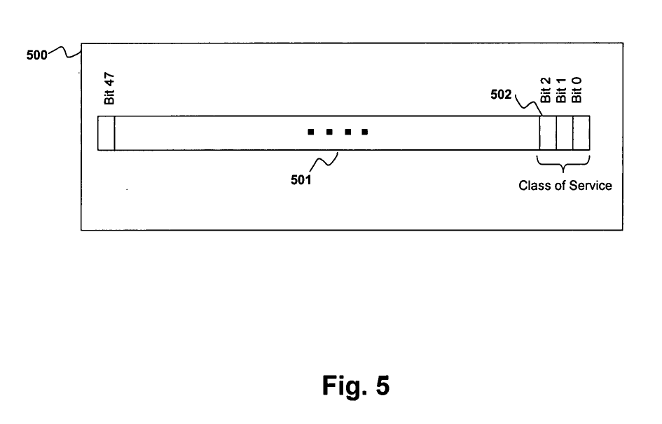

FIG. 5 shows an exemplary encoding Class of Service information in Virtual MAC address according to one embodiment. The MAC address 501 is 48 bit long, and the three least significant bits 501 are used for encoding the Class of Service information.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method performed by a network element, comprising:
maintaining a MAC (media access control) translation table (MAT) within a network element, the MAT table mapping a physical MAC address with a virtual MAC address for each of a plurality of clients of a local network; and
performing layer-2 routing on network traffic with respect to each of the clients based on information stored within the MAT.

2. The method of claim 1, wherein the MAT table is configured to encode additional information, including class of service in at least one virtual MAC address.

3. The method of claim 2, further comprising performing layer-2 management functionalities based on encoded information stored in the MAT table.

4. The method of claim 2, further comprising classifying network traffic according the encoded class of service information stored within the MAT table.

5. The method of claim 1, further comprising:
receiving a packet from a first client over a local network destined to a first destination over an external network; and
replacing, as a part of layer-2 routing, a source MAC address of the packet with a virtual MAC address associated with the first client based on the MAT table.

6. The method of claim 5, further comprising:
receiving a packet from a remote node over the external network destined to a second client of the local network; and
replacing, as a part of layer-2 routing, a destination MAC address of the packet with a physical MAC address associated with the second client based on the MAT table.

7. A machine-readable medium having instructions, when executed by a machine, causes the machine to perform a method, the method comprising:
maintaining a MAC (media access control) translation table (MAT) within a network element, the MAT table mapping a physical MAC address with a virtual MAC address for each of a plurality of clients of a local network; and
performing layer-2 routing on network traffic with respect to each of the clients based on information stored within the MAT.

8. The machine-readable medium of claim 7, wherein the MAT table is configured to encode additional information, including class of service in at least one virtual MAC address.

9. The machine-readable medium of claim 8, wherein the method further comprises performing layer-2 management functionalities based on encoded information stored in the MAT table.

10. The machine-readable medium of claim 8, wherein the method further comprises classifying network traffic according the encoded class of service information stored within the MAT table.

11. The machine-readable medium of claim 7, wherein the method further comprises:
receiving a packet from a first client over a local network destined to a first destination over an external network; and
replacing, as a part of layer-2 routing, a source MAC address of the packet with a virtual MAC address associated with the first client based on the MAT table.

12. The machine-readable medium of claim 11, wherein the method further comprises:
receiving a packet from a remote node over the external network destined to a second client of the local network; and
replacing, as a part of layer-2 routing, a destination MAC address of the packet with a physical MAC address associated with the second client based on the MAT table.
